(19) United States
(12) Patent Application Publication
(10) Pub. No.: US 2026/0154766 A1
(43) Pub. Date: Jun. 4, 2026

(54) SENSOR-BASED AUTHENTICATION AND SAFETY PROTOCOL VALIDATION

(71) Applicant: JABIL INC., St. Petersburg, FL (US)

(72) Inventor: JONATHAN M. DARCY, St. Petersburg, FL (US)

(21) Appl. No.: 19/123,592

(22) PCT Filed: Oct. 31, 2023
(86) PCT No.: PCT/US2023/078275

§ 371 Date: Apr. 23, 2025

Related U.S. Application Data
(60) Provisional application No. 63/381,857, filed on Nov. 1, 2022.

(51) Int. Cl. G06Q 50/26

(52) U.S. Cl. CPC G06Q 50/265; G06V 40/10; G06V 40/117; G06V 40/12; G06V 40/16

(57) ABSTRACT

A system, apparatus and method for sensing, for a requested activity by a requesting user, both an acceptability of a user identity and a validation of safety protocols are described herein. The embodiments include at least; at least one local sensor; a local microprocessor and associated memory capable of training and actuating the local sensor, the local sensor capable of sensing at least first characteristics of the user identity and second characteristics of the safety protocols; and a comparator for comparing the first characteristics to a first acceptable data profile and the second characteristics to a second acceptable data profile, and for outputting an affirmation of the requested activity only if both the first characteristics meet the first acceptable data profile, and the second characteristics meet the second acceptable data profile. The output of the affirmation actuates the requested activity solely for the requesting user.

### CROSS-REFERENCE TO RELATED APPLICATIONS

This application claims priority to U.S. Provisional Application No. 63/381,857 filed on Nov. 1, 2022, the contents of which are incorporated herein by reference in its entirety.

### BACKGROUND

### Field of the Disclosure

The present disclosure relates to user authentication and, more particularly, to an apparatus, system and method related to sensor-based identity authentication and safety protocol validation.

### Description of the Background

Individuals may request to engage in an activity that may be safe in some but unsafe in other circumstances. A variance in safety in such activities may occur because of a number of factors, such as the age or credentials of a requesting user, or because the activities necessitate peripheral aspects without which the activities are unsafe, such as the need to wear a hard hat, goggles or other personal safety or other safety equipment.

Individual identification, such as badge scans, are sometimes used for identification upon receipt of a request to engage in certain activities. For example, entering a restricted access area or building or prospective airline passenger identification.

### SUMMARY

The embodiments disclosed are and include a system, apparatus and method for sensing, for a requested activity by a requesting user, both an acceptability of a user identity and a validation of safety protocols. The embodiments include at least: at least one local sensor; a local microprocessor and associated memory capable of training and actuating the local sensor, the local sensor capable of sensing at least first characteristics of the user identity and second characteristics of the safety protocols; and a comparator for comparing the first characteristics to a first acceptable data profile and the second characteristics to a second acceptable data profile, and for outputting an affirmation of the requested activity only if both the first characteristics meet the first acceptable data profile, and the second characteristics meet the second acceptable data profile. The output of the affirmation then actuates the requested activity solely for the requesting user.

Thus, the embodiments can not only sense authorized users, but can also sense features which make an environment to which a user has requested access more safe. These embodiments are provided with minimal or no added expense over known identification-sensing embodiments.

### BRIEF DESCRIPTION OF THE DRAWINGS

The exemplary apparatuses, systems, and methods shall be described hereinafter with reference to the attached drawings, which are given by way of non-limiting example only, in which like numerals may represent like-elements, and in which:

FIG. 1 illustrates aspects of the embodiments;

FIG. 2 illustrates aspects of the embodiments; and

FIG. 3 illustrates aspects of the embodiments.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that embodiments may be embodied in different forms. As such, the embodiments should not be construed to limit the scope of the disclosure. As referenced above, in some embodiments, well-known processes, well-known device structures, and well-known technologies may not be described in detail.

The terminology used herein is for the purpose of describing particular embodiments only and is not intended to be limiting. For example, as used herein, the singular forms “a,” “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on,” “upon,” “connected to” or “coupled to” another element or layer, it may be directly on, upon, connected or coupled to the other element or layer, or intervening elements or layers may be present, unless clearly indicated otherwise. In contrast, when an element or layer is referred to as being “directly on,” “directly upon,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the embodiments.

Processor-implemented modules, systems and methods may be disclosed herein that may provide access to and transformation of a plurality of types of digital content, including but not limited to video, image, text, audio, metadata, algorithms, identifiers, interactive and document content, which, alone or in combination, track, deliver, manipulate, transform, transceive and report the accessed content to control and execute the processes discussed herein. Described embodiments of these modules, systems and methods processed by a processing system are intended to be exemplary and not limiting.

Furthermore, it will be understood that the terms “module” or “engine”, as used herein, do not limit the functionality to particular physical modules, but may include any number of tangibly-embodied software and/or hardware components having the aforementioned transformative effect on at least a portion of a system. In general, a computer program product in accordance with one embodiment comprises a tangible computer usable medium (e.g., standard RAM, an optical disc, a USB drive, or the like) having computer-readable program code embodied therein/thereon, wherein the computer-readable program code is adapted to be executed by a processor (such as working in connection with an operating system) to implement one or more functions and methods as described herein throughout. In this regard, the program code may be implemented in any desired language, and may be implemented as machine code, assembly code, byte code, interpretable source code or the like (e.g., via C, C++, C #, Java, Actionscript, Objective-C, Javascript, CSS, XML, etc.).

Embodiments of the present invention may sense safety features for authorized users prior to activity approval, such as building or area access—as opposed to a job foreman visually ensuring that on-site equipment operators are wearing hard hats, or a lab technician ensuring that those who enter a lab are wearing lab coats, goggles, and gloves.

Embodiments of the present invention that can not only sense authorized users, but which can also sense features which make an environment to which a user has requested access more safe may be employed.

By way of non-limiting example, one or more modules may be provided which, when associated with a microprocessor, process data from a camera, and discern from said data what is within view of the camera providing the data. Accordingly, the module(s) may discern the identity of a person within view of the camera, and the presence of one or more safety garments worn by the identified person. In other embodiments, a camera may be used in conjunction with other access restriction or tracking technology, such as badge or code readers to capture analogous data.

Embodiments of the present invention may provide sensor-based identity authentication and sensor-based safety protocol validation. These aspects may be provided using a multi-sensor embodiment in which multiple different sensors are employed to provide these features; a single sensor embodiment in which a single sensor provides these features; or a single combination sensor in which a single sensor provides multiple functionality that allows for provision of the aforementioned two features.

Regarding the sensing performed to provide the identity authentication, it will be appreciated in light of the discussion herein that numerous different types of sensing may be provided. By way of nonlimiting example, suitable sensor(s) to provide identity authentication may include a camera, a fingerprint reader, a barcode reader, a Q.R. code reader, a card reader (such as to “see” or otherwise read an identification card or similar scannable card), a contour scanner, a biometric scanner (such as an eye scanner), an NFC tag reader, or the like.

Similarly, it will be understood that numerous different types of sensing/sensor(s) may be employed to provide the safety protocol validation aspect of the disclosed embodiments. Suitable sensors to perform the safety protocol validation may include, but are not limited to, a camera, an air characteristics reader, an infrared/temperature sensor, a barcode sensor, a Q.R. code sensor (for example, any code scanner capable of reading and identifying a tag on, for example, a lab coat or a hardhat), a pressure sensor, a weight sensor, a biometric scanner, a contour scanner, an NFC tag reader, and so on.

Thus, as is evident from the foregoing enumeration of different sensor types, the overlap between different types of sensors capable of performing either or both functions/aspects of the disclosed embodiments is evident. That is, as referenced above, the identity authentication and the safety protocol validation may use different sensors to perform the respective function from each of the foregoing lists in an independent multi-sensor format; in a single combination sensor format, such as wherein a camera and a scanner are both used; or in a single sensor multifunction format, such as in an embodiment in which a camera is used to perform both identity authentication and the safety protocol validation. It goes without saying that, in certain contexts, a single sensor embodiment may be more preferred than a multi-sensor embodiment, such as for reasons of the cost of multiple sensors; the difficulty in packaging multi-sensors, such as based on package size; the processing overhead needed to process output from multiple sensors, such as in an on-site, thick-client embodiment; or the communications and protocol overhead required to communicate with multiple sensors in a thin-client embodiment. In other implementations, multiple sensors may be desired, so as to support magnetic card reading capability in combination with fever sensing, for example.

As such, the selection of the number of sensors employed to provide the enumerated functionality may be decided by a balancing of numerous design factors. These factors may include, but are not limited to, sensing time available, the cost of the sensor or sensors, the reason for the sensing, i.e., the level of hazard associated with the activity in which the user is attempting to engage, the required processing on-site, the available space on-site for the sensing package, and so on.

By way of non-limiting example, the sensing performed may depend heavily on the time, place, and activity at and in which the user attempts to engage. For example, the sensing may attempt to discern, upon a user request, that the requesting user is identified as authorized to gain access/engage in an activity, and that the requisite safety equipment is present to allow for safe engagement in the activity/gain the access. In such an embodiment, the user may first be identified/classified/categorized, and then, by way of example, an assessment may be made whether or not any one or more of the following are present in association with the user: hardhat; safety goggles; lab coat; cleanroom gear; protective boots or gloves; and so on.

Other embodiments may discern other safety protocol validations, but may be more focused on discerning unauthorized users. For example, an identified user may require, but may lack, a certification to perform a certain activity, such as in the case, for example, that the user is seeking to drive or otherwise operate a forklift, in which case the user might need a forklift operator's license. In such cases, the certification of the user's authorization may be specific to a user or users, or may be categorical as to an authorized or unauthorized user. That is, the user may have his or her forklift license “sensed”, and/or the user may have his or her identity sensed, and this identity may be compared to a list of authorized forklift operators who are known to have a forklift operator's license.

By way of further example, solely with regard to user identification, a user may request access to an in-home liquor cabinet. In such a case, any user identified as being over a certain predetermined age (such as the legal drinking age in the state in which access is requested) may be allowed to enter a liquor cabinet, while any user identified as being under that age may be disallowed from entry into that liquor cabinet. Likewise, only users identified as being on an authorized user list (i.e., a homeowner, a spouse, and grandparents) may be granted access to the liquor cabinet, regardless of the age provided by the sensing.

Further, there may be a temporal aspect to the sensed operations. For example, a denial of access to an activity may comprise a temporary exclusion, such as wherein an authenticated user is sensed by a breathalyzer safety protocol as having had too much to drink, or wherein an automobile operator is authenticated but is temporarily excluded from driving a vehicle because he or she is not wearing the driving glasses that are mandated based on the scan of his or her driver's license.

This temporal aspect may similarly include timing for corrective action. According to the example above, a forklift operator may be identified as an authorized operator, but may likewise be identified as lacking the requisite hard hat to perform the requested operation. In such a case, the subject forklift may be held “idle” for 10 minutes while awaiting the authorized user to return to wearing a hard hat. The user may or may not be allowed to avoid re-identification upon return, and such an embodiment would be of some importance in situations where there is heightened demand for access or to engage in an activity.

Additionally, it will be appreciated that, in a typical embodiment, the identity authentication sensing and safety protocol validation sensing may be performed at a local level, i.e., will generally be performed geographically at the point wherein the user seeks to engage in an activity. Of course, this may not always be the case.

In any event, the processing of the sensed data, and therefore the decision-making associated with the sensed data, may be performed locally or remotely. Further, the processing needs may be distributed between local and remote processing, such as based on the amount of processing necessary in a certain embodiment. That is, if minimal processing is necessary, such as wherein an authorized automobile user is first assessed, and must then pass a breathalyzer test, or must then pass a camera sensing test of placing a finger directly onto a nose repeatedly, before the vehicle operates, the processing may be performed on a user's mobile device, or by a vehicle's onboard computer, if the amount of processing of the sensed data that is needed is minimal. However, if more significant processing is needed, such as wherein a specialized pixel analysis is required to ensure that a user's safety goggles have a certain amount of thickness or UV protection, then that processing may be done remotely after the sensing data is communicated from the local point to the remote processing.

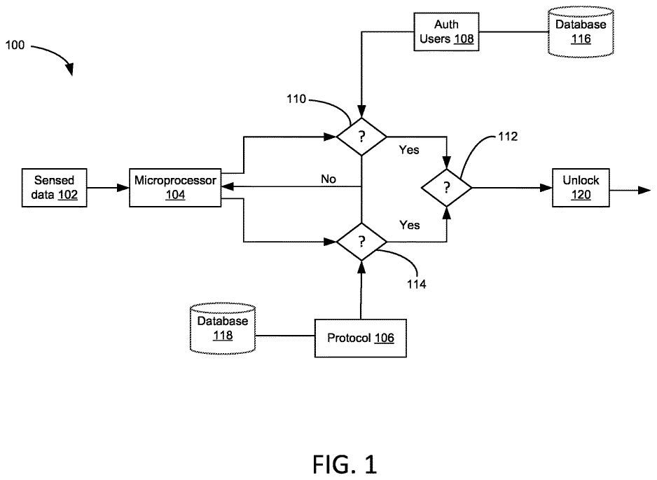

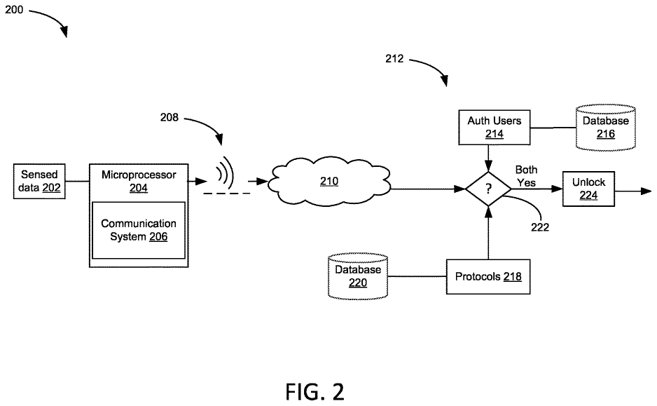

Whether the computing is performed locally, remotely, or is distributed between local and remote processing or in a cloud-type environment, the local sensor or sensors will generally read the data and upload or otherwise communicate gathered data, be it a magnetic code scan or pixel data from a camera. User authorization may be assessed first or later, and safety protocols validated first or later, and upon meeting of the required criteria for both sensed aspects, an activity lock or unlock issued, e.g., access granted. This is typically performed by receipt of the sensor data by one or more conventional computing devices to compare the authorized user list and the safety validation protocols, and the data profiles associated with each, to the received sensor data. For example, FIGS. 1 and 2 illustrate a local data processing and remote data processing embodiments, respectively.

FIG. 1 shows an embodiment of a processing environment 100 in which sensing is performed locally and the sensed data 102 is provided to a local microprocessor 104. The local microprocessor 104 includes local access to data profiles, such as those corresponding to Auth Users 108 and Protocols 106, that are acceptable for user authorization and safety protocol validation, respectively. Data profiles may be present, by way of non-limiting example, in a comparative/relational database resident, such as databases 116 and 118, in the aforementioned memory associated with the microprocessor 104.

These acceptable profiles are fed to one or more comparators, such as comparators 110, 112, and 114, that compare, pursuant to instructions from the microprocessor 104, the incoming sensor data 102 to the acceptable data profiles 106 and 108, and which issue multiple outputs based on that comparison. The comparator may be hardware or firmware, or may preferably be algorithmic software, and in each such case the comparator is effectuated/activated by the microprocessor 104, with comparator inputs comprising the sensor data feeds and the acceptable data profiles.

Possible outputs from the comparator include both “No” for compliance to the user authorization and to the safety protocol, one “Yes” for compliance to user authorization and one “No” for compliance to the safety protocol, one “No” for compliance to user authorization and one “Yes” for compliance to the safety protocol, and “Yes” for compliance to both user authorization and safety protocol validation. Only in the instance in which both data comparisons provide a “Yes” for compliance outcome to the acceptable data profile may the requested activity be enabled, such as by an unlock or activate output command 120 from the local microprocessing system 104.

Of course, a local display or other similar indication may be present at the sensing site in association with the system 104 of FIG. 1. This indication may detail to the requesting user that the requested activity has been affirmed, or, if two “Yes's” are not present for compliance with the two sensed aspects, the reason or reasons why the requested activity is not affirmed and actuated.

FIG. 2 illustrates an embodiment of a processing environment 200 that is distinct from FIG. 1, at least in that the local micro-processing system 204 is associated with a communication system 206 that, upon receipt of the sensed data 202 at the local micro-processing system 204, uploads the data, such as via wired or wireless communication 208, such as but not limited to cellular, Wi-Fi, Bluetooth, or the like, to the cloud 210. That is. FIG. 2 illustrates a “thin client” embodiment.

Upon receipt by the remote micro-processing system 212 of the sensed data 202 from the cloud 210, the remote system 212 compares the necessaries for compliance with both user authorization and safety protocol validation acceptable data profiles, such as those corresponding to Auth Users 214 and Protocols 218,, and again only enables an activity, such as by issuing an unlock or activate output command 224, if compliance with both the authorized user and safety protocol is sensed based on the sensor data 202 from the local site. Accordingly, the sensor data “stream” from the two sensed data outputs is, in either the local or remote processing case, compared to both sets of affirmation data, i.e., identity authorization and safety protocol compliance, by comparator 222. The local or remote comparator may preferably comprise software as indicated above, although in the aforementioned embodiments wherein the comparator 222 is hardware or firmware, the comparator 222 may be executed using the firmware of a sensor or sensors chip set, by way of example.

The comparison may occur in parallel, i.e., the sensed data for both the identification and the safety protocol may be compared for compliance to the acceptable data at the same time. Alternatively, the comparison may be serial. In the case of a serial comparison, it may be preferred that the identity authorization may occur first, as a lack of user authorization indicates that there is no need to engage in the processing needed to engage in the safety protocol data comparison.

Of note, regardless of the thick or thin client nature of the processing, i.e., whether or not the processing occurs locally or remotely, the comparator 222 only outputs an unlock or activate command 224 upon affirmation of both data sets. This dual affirmation may occur only in cases where both data streams indicate a precise data point via the comparison, or may occur if both data sets are within an allowable match range for the data. By way of nonlimiting example, with regard to user identification, particular matched data may require that a certain user be specifically identified; on the other hand, if an allowable match range is provided, the user identification may need only identify that the user is, for example, over 21 years of age.

If both data sets are within the allowable range or meet the specific data required, then the requested functionality may be unlocked, activated, or otherwise allowed to occur via an affirming output from the data comparisons by the microprocessor 204. As discussed throughout, this comparison functionality may be hardware functionality or software functionality, by way of nonlimiting example, but in any case the comparison is performed only at the instruction of the microprocessor 204.

More particularly, an allowable match range may vary based on any number of factors. For example, a match range may vary by sensor type. Likewise, the match range may vary by the requested activity, or by that to which access is requested. By way of nonlimiting example, a forklift may strictly require that the individual requesting authorization have in his or her possession a specific certification or license to operate, and be wearing a hardhat and safety gloves. On the other hand, the opening of a liquor cabinet may require that the individual identified be of a particular age, which age may be dependent upon the state in which the liquor cabinet resides, and additionally may require that the user pass a breathalyzer test to ensure that the user is not already intoxicated. In such a case, the breathalyzer may comprise the safety protocol to be validated. Further with respect to allowable ranges for data comparisons, the breathalyzer test may have a maximum allowable blood alcohol content that also varies by the state in which the liquor cabinet resides.

Furthermore, satisfaction of the two separate compared data sets, i.e., the user authorization and safety protocol compliance, may be interdependent of one another, and may cause variability in one another, or may not. For example, the safety protocol compliance check may be sensed only after the requesting user has been identified as an authorized user. Likewise, satisfaction of one data set criteria to a certain level within a match range may cause a variation in the data match threshold required in the other data set. By way of example, an undergraduate student in electrical engineering and a PhD in electrical engineering at a particular university may both be authorized to enter a laboratory cleanroom. However, it may be that the safety protocol compliance is less stringent upon identification that the PhD is requesting access, because it can be assumed that the PhD recognizes the level of cleanroom gear that is actually necessary to enter the facility more so than an undergraduate student would understand the safety gear actually necessary to enter the cleanroom.

It additionally may be the case that the embodiments include, preferably in a remote, cloud-based format, one or more learning modules. These learning modules may learn from data monitoring, such as based on global monitoring of the incoming data sets with respect to user identification and safety protocol compliance, as well as from additional incoming data, such as third-party data on accident, incident, arrest, or other reports, in such a manner that the required data matching performed by the comparator for the two data sets is modified. More specifically, the data match range or ranges may be modified by the learning module as the learning occurs. By way of example, incident reports may be compared by the learning module to categories of authorized user identifications, and thereby the safety protocol compliance is required to obtain a match range for the safety protocol may be varied, i.e., may become more stringent, for identified categories of users that experience higher negative incidents.

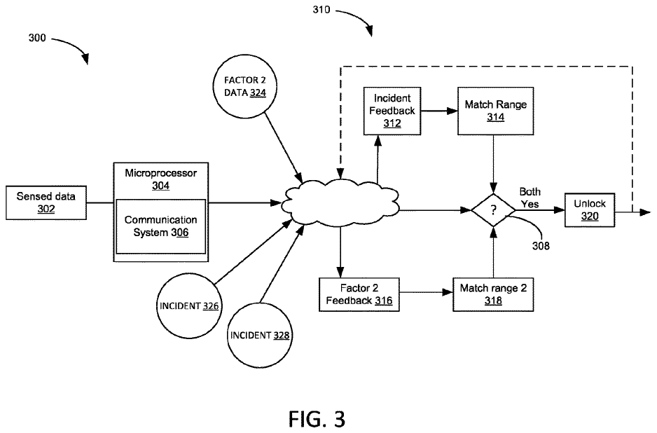

By way of nonlimiting example, FIG. 3 illustrates a processing environment 300 of a learning module capable of, either in an automated manner or using manual permissions, modifying a match range of at least one of the two data sets for which the comparator 308 performs the comparison to unlock or activate the requested functionality. In the illustration, a cloud-based learning module 310 receives a local data stream from the sensor or sensors at which the user requests permission to unlock or activate the requested functionality. Also received by the cloud-based learning module 310, such as from multiple third-party sources, are incident and accident reports by user category. Of note, the learning module 310 may also receive a large quantity of data for such requests, such as from a geographic region.

The learning module 310 begins with an initial allowable match range for both user identification and safety protocol compliance. This may comprise, for example, training data. However, as feedback is received based on the incoming incident and accident reports 324, 326, and 328, the match range 314 may be modified for either the user identification or the safety protocol compliance. This modified match range may then be applied upon subsequent user requests to unlock or activate requested functionality.

The disclosed embodiments may be, by way of nonlimiting example, app-based, or may operate based on simple remote server principles. In app-based embodiments, a local administrator or app administrator may be enabled to make modifications to, for example, lists of authorized users and/or safety protocols to which compliance is compared. Further, the sensor system, which may comprise one or multiple sensors as discussed throughout, may be subjected to controls through the app. Yet further, an administrator may be enabled, such as through the app, to change out the type of sensing used to obtain the data streams for comparison by the comparator. By way of example, this may allow for local replacement of failed sensors, or elimination of secondary sensors in use cases where a single sensor is capable of sensing both user identification and safety protocol compliance.

Simply put, various aspects of the disclosed embodiments may be administrated, controlled, read and/or processed by a user app, such as may be resident on a mobile device. Accordingly, the user app may be used to actuate and/or otherwise “wake up” local sensors to allow for user identification and safety protocol compliance sensing. For example, a user app may be employed to set up sensors, enter information, enter parameters, and so on. Similarly, a user app may act as processing for sensors or scanners which may be associated with the mobile device on which the user app resides.

Accordingly, the mobile device having thereon the resident user app may act as a gateway for some or all aspects of the disclosed embodiments, such as for both user identification and for safety protocol compliance, or for either measure. By way of nonlimiting example, the user app may then communicate with a locally accessible or actuatable entry point, appliance, or machinery. Once the applicant mobile device confirms that the user being read by the mobile device is properly identified as an authorized user and is in safety compliance, then the requested activity or function may be confirmed by the mobile device as available to that user. As such, the function may be locally provided, such as through an NFC tag read of the mobile device, a Bluetooth communication from the mobile device, a cellular communication from the mobile device, a Wi-Fi communication from the mobile device, or the like.

It will be appreciated that various identifications may be made in the disclosed embodiments to confirm availability of requested functionality. By way of nonlimiting example, such identifications may include: age; licensure; education; presence of an identification card; presence of a payment card; mobile device-based identifying information; facial recognition; eye print or similar biometric identification; the presence of one or more fingerprints; the recognition of a specific person or class of persons; an infrared signature identifying a certain size of a person; and the like.

Likewise, a variety of safety protocols may be assessed as to compliance in the embodiments. By way of nonlimiting example, such safety protocols may include: the presence of equipment; the presence of particular clothing; the presence of a particular bio status; the presence of an electronic key; the presence of particular environmental conditions; the occurrence of a particular timeframe; the presence at a particular place; and the like.

The foregoing identification confirmations and safety protocol compliance confirmations may enable a variety of particular functions and use contexts. By way of nonlimiting example, such use contexts may include: the operation of a vehicle; the operation of heavy equipment, such as a forklift, bulldozer, and the like; the operation of a motorbike; the operation of an airplane or similar flying device; the operation of a water-based vehicle: the accessibility to restricted locations; and the availability of restricted access based on predetermined conditions, such as access to a chemical cabinet based on education, or access to a liquor cabinet based on age.

Thus, the disclosure teaches a system, apparatus and method for sensing, for a requested activity by a requesting user, both an acceptability of a user identity and a validation of safety protocols. The apparatus, system and method may include at least: at least one local sensor; a local microprocessor and associated memory capable of training and actuating the local sensor, the local sensor capable of sensing at least first characteristics of the user identity and second characteristics of the safety protocols; and a comparator for comparing the first characteristics to a first acceptable data profile and the second characteristics to a second acceptable data profile, and for outputting an affirmation of the requested activity only if both the first characteristics meet the first acceptable data profile, and the second characteristics meet the second acceptable data profile. The output of the affirmation may then actuate the requested activity solely for the requesting user.

In certain embodiments of the present invention a camera may be advantageously used to sense both identity and whether the user is using mandated personal safety equipment, for example a hard hat, mask or shoe covers. This may be largely implemented in the computing environment to provide an improved access restriction system without a need for additional sensors. Conventional image recognition methods may be used with camera provided data to effect enhanced access control. Additionally, or in lieu thereof, visibly identifiable features such as barcodes or QR codes on personal safety equipment, like hard hats or lab coats, can be used to facilitate processing and access control in combination with one or more such cameras, such as additional camera(s) that have different views or different operating ranges, such as to sense a user's body temperature. In such a case, a separate scan of the user for fever may be obviated, as access is not approved by the access restriction system unless a sensed user temperature is within acceptable range(s).

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. A system for sensing, for a requested activity by a requesting user, both an acceptability of a user identity and a validation of safety protocols, comprising:
a single local sensor;
a local microprocessor and associated memory capable of training and actuating the single local sensor, the single local sensor capable of sensing at least first characteristics of the user identity and second characteristics of the safety protocols; and
a comparator for comparing the first characteristics to a first acceptable data profile and the second characteristics to a second acceptable data profile, and for outputting an affirmation of the requested activity only if both the first characteristics meet the first acceptable data profile, and the second characteristics meet the second acceptable data profile;
wherein the output of the affirmation actuates the requested activity solely for the requesting user.

2. The system of claim 1, wherein the single sensor is one of a fingerprint reader, a barcode reader, a Q.R. code reader, a card reader, a contour scanner, a biometric scanner, an NFC tag reader, a camera, an environmental sensor, an infrared sensor, a pressure sensor, and a weight sensor.

3. (canceled)

4. (canceled)

5. (canceled)

6. The system of claim 1, wherein a denial of the requested activity is temporal.

7. The system of claim 1, wherein a denial of the requested activity includes an idle time for curative measures by the requesting user.

8. The system of claim 7, wherein any affirmed characteristics are not re-sensed during the idle time.

9. (canceled)

10. (canceled)

11. The system of claim 1, further comprising a remote microprocessor with which the comparator is associated, wherein the local microprocessor controls communication with the remote microprocessor, and wherein the comparator is distributed between the local and the remote microprocessors.

12. (canceled)

13. (canceled)

14. (canceled)

15. (canceled)

16. The system of claim 1, wherein the comparing the first characteristics to a first acceptable data profile occurs before the comparing the second characteristics to a second acceptable data profile.

17. The system of claim 1, wherein the first and second acceptable data profiles are stored in a relational database resident in the associated memory.

18. (canceled)

19. (canceled)

20. (canceled)

21. The system of claim 1, wherein the comparator compares the first characteristics and the second characteristics in serial.

22. (canceled)

23. The system of claim 1, wherein the comparator compares the first characteristics and the second characteristics in parallel.

24. The system of claim 1, wherein comparisons by the comparator are to a specific data point in the acceptable data profiles, and wherein the specific data point for the first characteristic in the first acceptable data profile is one of an age, education level, and a certification level.

25. (canceled)

26. (canceled)

27. (canceled)

28. The system of claim 1, wherein comparisons by the comparator are to data ranges in the acceptable data profiles, and wherein the data range of the second characteristics is dependent upon the comparison of the first characteristics.

29. (canceled)

30. The system of claim 1, further comprising a learning module that modifies the first and second acceptable data profiles according to a plurality of ones of comparisons by the comparator.

31. (canceled)

32. (canceled)

33. (canceled)

34. (canceled)

35. (canceled)

36. A system for selectively facilitating an activity associated with at least one item of equipment by a subject, comprising:
a sensor providing an output; and
a controller communicatively coupled to the sensor and comprising code, which when processed by the controller:
identifies the subject responsively to the output;
determines the presence or absence of a safety criteria associated with the identified subject responsively to the output; and
provides a controller output signal;
wherein, the activity is selectively, automatically facilitated for the individual upon receipt of at least a portion of the controller output signal.

37. The system of claim 36, wherein the sensor is a camera, and the sensor output comprises data indicative of at least one image.

38. The system of claim 37, wherein the controller uses the data indicative of the at least one image to identify the individual.

39. The system of claim 38, wherein the controller uses the data indicative of the at least one image to determine presence or absence of at least one element of personal protective equipment associated with the individual.

40. The system of claim 39, wherein the at least one element of personal protective equipment comprises at least one of safety glasses, a hard hat, a lab coat, at least one piece of cleanroom gear, footwear and gloves.

41. The system of claim 39, wherein the activity is automatically facilitated in response to the determined presence of the at least one element of personal protective equipment.

42. The system of claim 41, wherein the activity is not automatically facilitated for the individual in response to the determined absence of the at least one element of personal protective equipment.
